(19) United States
(12) Patent Application Publication
(10) Pub. No.: US 2020/0260874 A1
(43) Pub. Date: Aug. 20, 2020

(54) METHOD FOR MANUFACTURING A SEAT SHELL FOR A SEAT

(71) Applicant: Interstuhl Bueromoebel GmbH & Co. KG, Messstetten-Tieringen (DE)

(72) Inventor: Joachim Link, Messstetten-Tieringen (DE)

(21) Appl. No.: 16/793,186

(22) Filed: Feb. 18, 2020

(30) Foreign Application Priority Data
Feb. 18, 2019 (DE) 10 2019 202 148.4

(51) Int. Cl. A47C 3/12; A47C 5/12

(52) U.S. Cl. CPC A47C 3/12; B29C 45/0001; A47C 5/12

(57) ABSTRACT

A method for manufacturing a seat shell for a chair includes three method steps (a) to (c). According to a first step (a), a carrier made of a plastic material is provided, on the front side of which a plastic film is arranged. According to a second step (b), the carrier with the plastic film is deep drawn by a deep drawing tool such that the front side of the carrier with the plastic film has a predefined three-dimensional surface contour after the deep drawing. According to a third step (c), a rear side of the carrier is encapsulated by injection molding with the plastic material.

### CROSS REFERENCE TO RELATED APPLICATIONS

This application claims priority to German patent application DE 10 2019 202 148.4, filed Feb. 18, 2019, the entire content of which is incorporated herein by reference.

### TECHNICAL FIELD

The disclosure relates to a method for manufacturing a seat shell for a seat and to a seat shell. In addition, the disclosure relates to a chair having a seat shell which is manufactured, in particular by this method.

### BACKGROUND

Modern seat shells for chairs are often provided on the upper side with a decorated film which is composed of plastic, in order in this way to be able to make the upper side of the seat shell visually individual and correspondingly attractive to a viewer. Typically, such seat shells composed of plastic are manufactured using an injection molding method. The term “seat shell” is to be interpreted widely in the present context and includes not only pure shell-like geometries but also sitting surfaces with other geometries which are suitable for a chair.

It proves problematic to manufacture such seat shells if they are to be equipped with said plastic films, since the seat shells typically have a curved surface contour. The surface contours of the seat shell are often even curved “doubly”, which means that a curvature of the surface contour is present not only in a single direction but also even in two directions which extend perpendicularly with respect to one another.

### SUMMARY

It is an object of the present disclosure to provide an improved manufacturing method for a seat shell of a chair. A further object of the present disclosure is to provide such a seat shell.

The objects are achieved by a method for manufacturing a seat shell for a chair, a seat shell for a chair, and a chair, as described herein.

A basic concept of the disclosure is to arrange a decoratively configured plastic film, for use on a seat shell for a chair, firstly on a relatively thin-walled carrier composed of a plastic material, and then to deep draw the carrier with the plastic film into the desired geometric shape and subsequently encapsulate the carrier with plastic by injection molding in order to form the actual seat shell.

The use of a carrier on which the plastic film is positioned and attached before the deep drawing and the subsequent injection molding of the plastic material makes the manufacture of a seat shell with a variety of different surface contours and surface curvatures possible. In this context, the upper side of the seat shell, which can form both a sitting surface and a backrest of the chair, can be made more attractive by the decorative plastic film, which increases the quality of the seat shell and therefore of the entire chair using the seat shell.

A method according to an aspect of the disclosure for manufacturing a seat shell for a chair includes the steps a) to c) explained below: according to a first step a) a carrier composed of a plastic material on the front side of which a plastic film is arranged is made available. According to a second method step b), the carrier with the plastic film is deep drawn by a deep drawing tool so that the front side of the carrier with the plastic film has a predefined, three-dimensional surface contour after the deep drawing. In a third method step c), the rear side of the carrier is encapsulated with a plastic material by injection molding. In this way, a shell body is formed which makes the carrier with the plastic film rigid to such an extent that the seat shell which is formed from the carrier with the plastic film and the shell body is sufficiently stable to be able to be installed in a chair without further measures of stabilization.

According to an aspect of the method, the encapsulation by injection molding is carried out in step c) by a mono-sandwich method. This has the result that there can be a saving in respect of the quantity of plastic which forms the sitting surfaces of the seat shell on the other side of the plastic film and provides attractive optics, without in the process worsening the rigidity of the seat shell or the manufacturing time of the seat shell.

According to a further aspect of the disclosure, in a mono-sandwich method by which the rear side of the carrier is encapsulated by injection molding with the plastic material in step c), a core component is first plasticized in an injection unit of an injection tool, and subsequently a skin component is dosed by a secondary extruder in a screw vestibule of the injection unit. In this context, the materials located in the cylinder are not mixed but instead become deposited in the screw vestibule spatially one behind the other so that when the injection occurs the two materials inevitably flow in succession into the cavity so that the plastic component which flows in first is laid down as a skin component on the rear side of the carrier, and the following plastic component forms the core of a shell body. A sandwich-like structure of the seat shell can be particularly easily achieved in this way.

In the mono-sandwich method by which the rear side of the carrier is expediently encapsulated by injection molding with the plastic material in step c), the injection tool is equipped with a standard injection molding machine with the secondary extruder in a vertical or horizontal arrangement. This affords advantages in respect of the manufacturing costs of the seat shell.

According to a further aspect of the disclosure, in the mono-sandwich method by which the rear side of the carrier is encapsulated by injection molding with the plastic material in step c), the melt is guided through a nozzle out of the secondary extruder and in front of a closed non-return valve of the injection unit, and the already plasticized plastic melt and the screw are pressed back against an adjustable back pressure until the dosing path which has been set is achieved. This permits a particularly uniform structure of the layers of the seat shell which are generated in the mono-sandwich method.

According to one exemplary embodiment, in step c) a shell body is molded or formed on the rear side of the carrier, which shell body forms, together with the carrier and the plastic film, a seat shell for a chair. In order to form the chair, one or more chair legs can therefore be attached to the seat shell. Further mounting steps for assembling such a chair are not necessary in this exemplary embodiment.

The encapsulation by injection molding according to step c), expediently takes place in such a way that during the encapsulation by injection molding according to step c) a plastic melt composed of plastic material is injected onto the rear side of the carrier by an injection tool. This plastic melt is heated and melts the plastic material of the carrier when it impacts on the carrier so that said plastic material fuses with the injected plastic melt to form the shell body.

According to an aspect of the disclosure, the front side of the carrier which is made available in step a) and has the plastic film has, after the deep drawing according to step b), a curved three-dimensional surface contour at least in two directions which extend orthogonally with respect to one another. Such a “double” curvature corresponds to the geometries which are typically used for seat shells of modern chairs. In particular, the characteristic shell-shaped geometry of such a seat shell can be implemented in this way.

According to another aspect of the disclosure, the three-dimensional surface contour, predefined in step b), of the front side of the carrier with plastic film corresponds to the three-dimensional surface contour of a mold base which bounds a mold cavity in which the carrier with the plastic film is introduced in order to perform encapsulation by injection molding according to step c). This measure permits carriers with a wide variety of geometric shapes or surface contours to be encapsulated with a plastic material by injection molding in order to form the seat shell.

The plastic film which is arranged on the front side of the carrier is particularly expediently made to bear in a planar fashion on the mold base in order to perform encapsulation by injection molding according to step c).

According to an aspect of the disclosure, during the encapsulation by injection molding the plastic film is secured electrostatically to the mold base. This measure prevents intermediate spaces from being formed between the mold base and the plastic film, which intermediate spaces are filled in an undesirable fashion with plastic melt during the encapsulation by injection molding so that they cover the plastic film.

According to an exemplary embodiment, the same plastic material is used for the carrier and for the encapsulation of the carrier by injection molding. Such uniform selection of material promotes the fusing of the plastic material injected into the injection tool with the plastic material of the carrier. Furthermore, a uniform external appearance is produced for the seat shell which is formed.

Polypropylene can particularly expediently be used as the plastic material for the carrier and, alternatively or additionally, for the encapsulation of the carrier by injection molding.

A carrier which is embodied in a planar fashion and has a carrier thickness between 0.3 millimeters (mm) and 0.7 mm is expediently used for the encapsulation by injection molding. Such a carrier has the necessary stability to rule out damage to the plastic film, in particular by mechanical deformation of the carrier, before and during the encapsulation of the carrier by injection molding.

The encapsulation of the carrier by injection molding with plastic material for forming the shell body takes place in such a way that the shell body which is molded on the carrier has a body thickness between 4.5 mm and 8 mm. In this way, a seat shell which has the rigidity which is necessary for use as a chair is provided by the encapsulation by injection molding.

The disclosure also relates to a seat shell of a chair, which has been manufactured by the method explained above. The advantages of the method explained above are therefore also transferred to the seat shell according to an aspect of the disclosure.

The disclosure also relates to a seat shell for a chair, which seat shell includes a carrier composed of plastic material, on the front side of which a plastic film is arranged. According to an aspect of the disclosure, a shell body composed of plastic material is molded integrally onto the rear side of the carrier.

According to an exemplary embodiment, the front side of the carrier with the plastic film has a curved surface contour at least in two directions which extend orthogonally with respect to one another.

The carrier and the shell body are typically composed of the same plastic material or of different plastic materials.

According to an aspect of the disclosure, the carrier has a carrier thickness between 0.3 mm and 0.7 mm. A carrier thickness which is defined in such a way is sufficient to ensure the stability which is necessary to support the plastic film.

According to an aspect of the disclosure, the shell body has a body thickness between 4.5 mm and 8 mm. This ensures that the seat shell which includes the shell body has the mechanical stability which is necessary for use as part of a chair.

The disclosure also relates to a chair having a seat shell according to an aspect of the disclosure as presented above, which seat shell forms a sitting surface and/or a backrest of the chair. In addition, the chair has at least one chair leg, typically four chair legs, attached to the seat shell.

The features which are mentioned above and which are subsequently explained below can be used not only in the respectively specified combination but also in other combinations or alone without departing from the scope of the present disclosure.

### BRIEF DESCRIPTION OF THE DRAWINGS

The disclosure will now be described with reference to the drawings wherein:

FIG. 1 shows a highly simplified illustration of a carrier with a plastic film, which carrier is to be encapsulated by injection molding using the method according to the disclosure,

FIG. 2 shows a highly simplified illustration of an injection tool in which the encapsulation of the carrier with the plastic film is carried out by injection molding,

FIG. 3 shows an illustration showing the structure of the seat shell manufactured by the method, and

FIG. 4 shows an example of a chair using the seat shell according to the disclosure.

### DESCRIPTION OF EXEMPLARY EMBODIMENTS

Exemplary embodiments of the disclosure are illustrated in the drawings and are explained in more detail in the following detailed description, wherein identical reference symbols relate to identical or similar or functionally identical components.

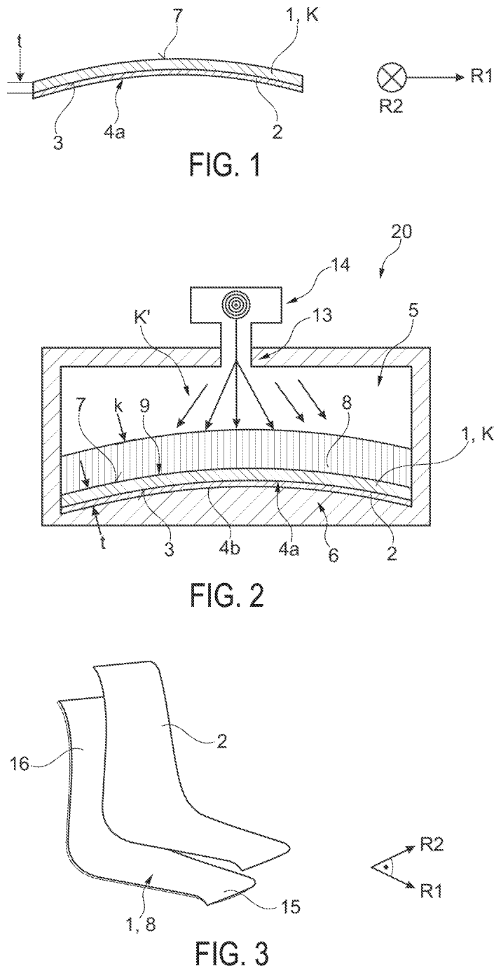

The method according to an exemplary embodiment of the disclosure will be explained by way of example below with reference to FIG. 1. According to a first method step a) a carrier 1 composed of a plastic material K is made available. The carrier 1 which is formed in the planar or panel-like fashion and which has a carrier thickness t between 0.3 mm and 0.7 mm is expediently used. In the exemplary embodiment shown in the figures, the carrier thickness t is approximately 0.55 mm.

As shown in FIG. 1, a plastic film 2 is arranged on a front side 3 of the carrier 1. According to a second method step b), the carrier 1 including the plastic film 2 is deep drawn by a suitable deep drawing tool (not shown in FIG. 1 for the sake of clarity) in such a way that the front side 3 of the carrier 1 with the plastic film 2 has a predefined, three-dimensional surface contour 4a after the deep drawing.

FIG. 1 shows the carrier 1 with the plastic film 2 after the deep drawing in a sectional illustration. After the deep drawing, the front side 3 of the carrier 1 and therefore also the plastic film 2 have a curved surface contour 4a in two directions R1 and R2 which extend orthogonally with respect to one another. Since the direction R2 in the exemplary embodiments shown in the figures extends perpendicularly with respect to the plane of the drawing, the front-side curvature of the surface contour 4a of the carrier 1 with the plastic film 2 cannot be seen in this direction R2 in FIG. 1.

As shown in FIG. 2, the carrier 1 with the plastic film 2 is introduced, after the deep drawing, into an injection tool or injection molding tool 20 which has a mold cavity 5 for this purpose, in which mold cavity the carrier 1 with the plastic film 2 is arranged. The mold cavity 5 is bounded on the base side by a mold base 6. The three-dimensional surface contour 4a, predefined in step b), of the front side 3 of the carrier 1 with the plastic film 2 corresponds here to a three-dimensional surface contour 4b of the mold base 6 which bounds the mold cavity. The surface contour 4b of the mold base 6 and the surface contour 4a of the front side 3 of the carrier 1 are therefore matched to one another.

For the encapsulation by injection molding according to step c), the plastic film 2 which is arranged on the front side 3 of the carrier 1 and therefore also the carrier 1 itself are made to bear in a planar fashion on the mold base 6 of the mold cavity 5. Since the surface contours 4a and 4b of the mold base 6 and the carrier 1 are matched to one another, when the plastic film 2 is arranged on the mold base 6 an intermediate space is not formed between the plastic film 2 and the mold base. For the injection process which now follows, the plastic film 2 and therefore also the carrier 1 can be secured electrostatically to the mold base 6.

According to step c), a rear side 7 of the carrier lying opposite the front side 3 is encapsulated by injection molding by the injection tool 20, said carrier having a plastic material K′. For this purpose, in a known fashion a plastic material K′ is injected from a nozzle 13 of the injection tool 20 into the mold cavity 5. Identical plastic materials K and K′, that is to say K=K′, are expediently used for the carrier 1 which is made available in step a) and for the encapsulation of the carrier 1 by injection molding according to step c). However, it is also conceivable to use different plastic materials K and K′ for the carrier 1 which is made available in step a) and for the encapsulation of the carrier 1 by injection molding according to step c). Polypropylene can expediently be used as the plastic material K and K′ for the carrier 1 and for the encapsulation of the carrier 1 by injection molding.

During the encapsulation by injection molding according to step c), a plastic melt 9 composed of the plastic material K′ is injected onto the rear side 7 of the carrier 1 by the injection tool 20, so that the plastic melt 9 fuses with the carrier 1. In this way, a shell body 8 is molded or formed on the rear side 7 of the carrier 1, which shell body 8 forms, together with the carrier 1 and the plastic film, a seat shell 12 for a chair 10 (not shown in FIG. 2).

In one variant, the encapsulation by injection molding can be carried out according to what is referred to as the “mono-sandwich method” in which the injection tool 20 is equipped with a standard injection molding machine with a secondary extruder in an optionally vertical or horizontal arrangement (not illustrated in more detail in FIG. 2). Firstly, the core component is plasticized in an injection unit 14 (indicated only in a rough schematic fashion in FIG. 2) of the injection tool 10. Subsequently, the secondary extruder doses the skin component into a screw vestibule of the injection unit. The melt flows through the nozzle 13 out of the secondary extruder in front of the closed non-return valve (not shown) of the injection unit 14 and the plastic melt, which is already plasticized, and the screw are pressed back against an adjustable back pressure until the set dosing path is achieved. In this context, the materials which are located in the cylinder are not mixed but instead are deposited spatially one behind the other in the screw vestibule. During the injection process, the two materials therefore flow inevitably in succession into the cavity, which results in the plastic component which flows in first being laid down as a skin component on the rear side 7 of the carrier 1, while the subsequent plastic component then forms the core of the shell body 8.

FIG. 3 illustrates the structure of a seat shell 12 which has been manufactured by the method according to an exemplary embodiment of the disclosure as explained above. Accordingly, the seat shell 12 includes the carrier 2 on the rear side 7 of which the shell body 8 is molded integrally. The seat shell 12 forms in the example in FIG. 3 both a seating surface 15 and a backrest 16 of a chair 10. According to FIG. 3, the plastic film 2 is arranged on the front side 3 of the carrier 1. For the sake of better illustration, in FIG. 3, the plastic film 2 is illustrated at a distance from the carrier 1. Of course, the plastic film 1 is placed in a planar fashion on the front side 3 of the carrier 1.

As is illustrated by FIG. 3, the carrier 1 with the plastic film 2 has a curved surface contour 4a in two directions R1 and R2 which extend orthogonally with respect to one another. The carrier 1 can have a carrier thickness between 0.3 mm and 0.7 mm, measured perpendicularly with respect to the sitting surface formed by the seat shell. In the exemplary embodiment shown in FIG. 3, the carrier thickness is 0.55 mm. The shell body 8 can have a body thickness k between 10 mm and 20 mm measured in the same direction as the carrier thickness t.

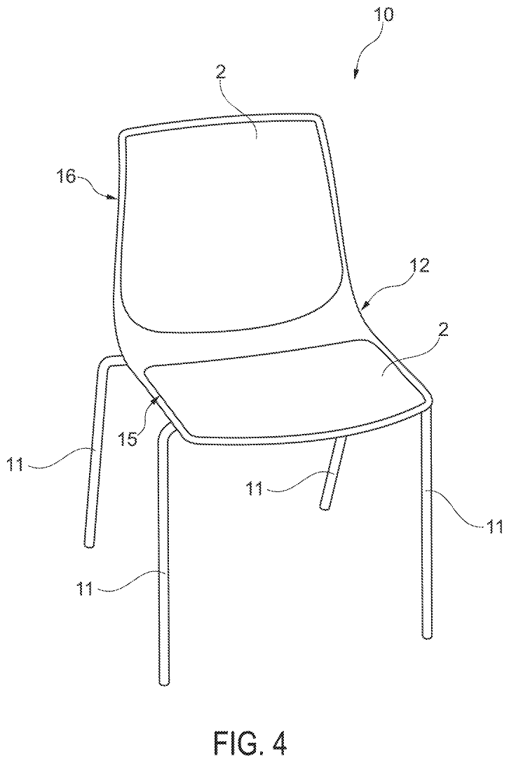

As shown in FIG. 4, chair legs 11 can be mounted on the seat shell 12 shown in FIG. 3, and in this way the chair 10 can be completed.

Further additional method steps for manufacturing the chair 10 are not necessary.

It is understood that the foregoing description is that of the exemplary embodiments of the disclosure and that various changes and modifications may be made thereto without departing from the spirit and scope of the disclosure as defined in the appended claims.

What is claimed is:

1. A method for manufacturing a seat shell for a chair, the method comprising:
(a) providing a carrier made of a plastic material and having a front side, and arranging a plastic film on the front side;
(b) deep drawing the carrier with the plastic film by a deep drawing tool such that the front side of the carrier with the plastic film has a predefined, three-dimensional surface contour after the deep drawing; and
(c) encapsulating by injection molding a rear side of the carrier with the plastic material.

2. The method according to claim 1, wherein the encapsulating by the injection molding in step (c) is carried out with a mono-sandwich method.

3. The method according to claim 2, further comprising:
in the mono-sandwich method by which the rear side of the carrier is encapsulated by the injection molding with the plastic material in step (c), plasticizing a core component first in an injection unit of an injection tool, and subsequently dosing a skin component by a secondary extruder in a screw vestibule of the injection unit, and
wherein materials located in a cylinder are not mixed but instead become deposited in the screw vestibule spatially one behind the other such that when an injection occurs, two materials inevitably flow in succession into a cavity such that the plastic component which flows in first is laid down as the skin component on the rear side of the carrier, and
wherein a following plastic component forms a core of a shell body.

4. The method according to claim 2, further comprising:
in the mono-sandwich method by which the rear side of the carrier is encapsulated by the injection molding with the plastic material in step (c), equipping an injection tool with a standard injection molding machine with a secondary extruder in a vertical or horizontal arrangement.

5. The method according to claim 2, further comprising:
in the mono-sandwich method by which the rear side of the carrier is encapsulated by the injection molding with the plastic material in step (c), guiding a melt through a nozzle out of a secondary extruder and in front of a closed non-return valve of an injection unit, and pressing back the already plasticized plastic melt and a screw against an adjustable back pressure until a dosing path which has been set is achieved.

6. The method according to claim 1, further comprising:
as a result of the encapsulating by the injection molding according to step (c), molding or forming on the rear side of the carrier a shell body which forms, together with the carrier and the plastic film, the seat shell for the chair, to which seat shell chair legs can be attached.

7. The method according to claim 1, further comprising:
during the encapsulating by the injection molding according to step (c) injecting a plastic melt composed of the plastic material by an injection tool onto the rear side of the carrier such that the plastic melt fuses with the carrier.

8. The method according to claim 1, wherein the front side of the carrier which is provided in step (a), and which has the plastic film, has, after the deep drawing according to step (b), a curved three-dimensional surface contour at least in two directions which extend orthogonally with respect to one another.

9. The method according to claim 1, wherein the three-dimensional surface contour, predefined in step (b), of the front side of the carrier with the plastic film corresponds to the three-dimensional surface contour of a mold base which bounds a mold cavity in which the carrier with the plastic film is introduced to perform the encapsulating by the injection molding according to step (c).

10. The method according to claim 1, further comprising:
making the plastic film, which is arranged on the front side of the carrier, to bear in a planar fashion on a mold base in order to perform the encapsulating by the injection molding according to step (c).

11. The method according claim 1, further comprising:
securing during the encapsulating by the injection molding according to step (c) the plastic film electrostatically to a mold base.

12. The method according to claim 1, wherein a same plastic material or different plastic materials are used for the carrier and for the encapsulating of the carrier by the injection molding.

13. The method according to claim 1, wherein the plastic material for the carrier and/or for the encapsulating of the carrier by the injection molding is polypropylene.

14. The method according to claim 1, wherein the carrier, which is embodied in a planar fashion, has a carrier thickness between 0.3 mm and 0.7 mm.

15. The method according to claim 1, further comprising:
performing the encapsulating by the injection molding according to step (c) such that a shell body which is molded on the carrier has a body thickness between 10 mm and 15 mm.

16. The seat shell for the chair, the seat shell comprising:
the carrier made of the plastic material and having the front side;
a plastic foil arranged on the front side;
a shell body integrally molded onto the rear side of the carrier and being made of the plastic material, and
wherein the seat shell is manufactured by the method according to claim 1.

17. The seat shell according to claim 16, wherein the front side of the carrier with the plastic film has a curved surface contour at least in two directions which extend orthogonally with respect to one another.

18. The seat shell according to claim 16, wherein the carrier and the shell body are made of a same plastic material or of different plastic materials.

19. The seat shell according to claim 16, wherein the carrier has a carrier thickness between 0.3 mm and 0.7 mm, and
wherein the shell body has a body thickness between 10 mm and 15 mm.

20. The chair comprising:
the seat shell according to claim 16 which forms a sitting surface and/or a backrest of the chair, and
at least one chair leg attached to the seat shell.
